(19) United States
(12) Patent Application Publication
(10) Pub. No.: US 2011/0083972 A1
(43) Pub. Date: Apr. 14, 2011

(54) ELECTROCHEMICAL METHOD AND APPARATUS FOR REMOVING COATING FROM A SUBSTRATE

(75) Inventors: Funsho K. Ojebuoboh, Aurora, CO (US); Wenming Wang, Toledo, OH (US)

(73) Assignee: First Solar, Inc., Perrysburg, OH (US)

(21) Appl. No.: 12/901,202

(22) Filed: Oct. 8, 2010

Related U.S. Application Data
(60) Provisional application No. 61/249,901, filed on Oct. 8, 2009.

(51) Int. Cl. B23H 3/00; C25B 9/00

(52) U.S. Cl. 205/674; 205/640; 204/242

(57) ABSTRACT

A method of removing coating from a substrate may include contacting at least a portion of a surface of a substrate to an electrolytic substance, where at least a portion of the surface includes cadmium; connecting a power source to the substrate and to an anode material; applying a current and a voltage; and removing at least a portion of coating from the substrate.

### CLAIM FOR PRIORITY

This application claims priority under 35 U.S.C. §119(e) to U.S. Provisional Patent Application Ser. No. 61/249,901 filed on Oct. 8, 2009, which is hereby incorporated by reference.

### TECHNICAL FIELD

The present invention relates to the production of photovoltaic modules and methods of recycling the active elements.

### BACKGROUND

Photovoltaic modules can include semiconductor material deposited over a substrate, for example, with a first layer serving as a window layer and a second layer serving as an absorber layer. The semiconductor window layer can allow the penetration of solar radiation to the absorber layer, such as a cadmium telluride layer, which converts solar energy to electricity. Photovoltaic modules can also contain one or more transparent conductive oxide layers, which are also conductors of electrical charge.

### DESCRIPTION OF DRAWINGS

FIG. 1 is a schematic of a configuration for an electrochemical leach of a coated substrate.

FIG. 2 is a schematic of a configuration for an electrochemical leach of a coated substrate.

FIG. 3 is a schematic depicting the gradual dissolution of coating from a substrate via electrochemical leach.

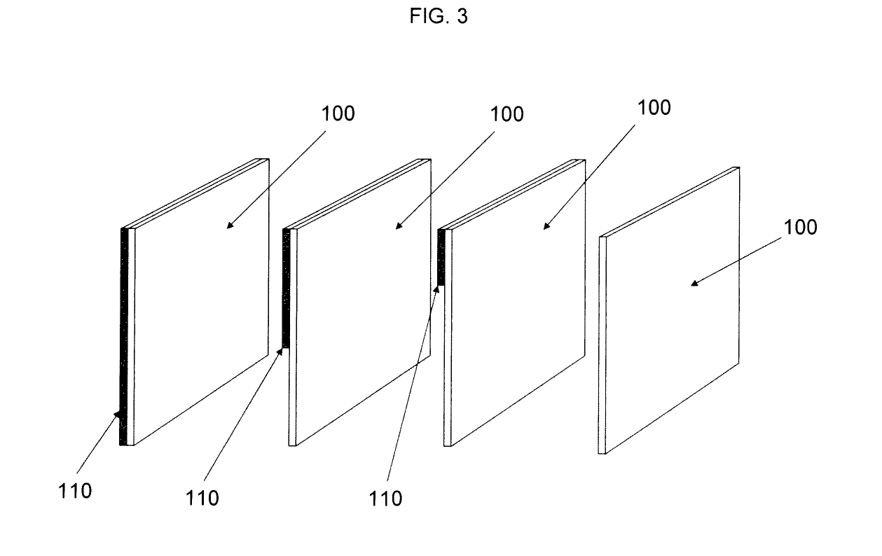

FIG. 4 is a schematic of an apparatus for electrochemically leaching coating from a substrate.

### DETAILED DESCRIPTION

A method of removing coating from a substrate may include contacting at least a portion of a surface of a substrate to an electrolytic substance, where at least a portion of the surface includes cadmium; connecting a power source to the substrate and to an anode material; applying a current and a voltage; and removing at least a portion of coating from the substrate.

The method may include various optional features. For example, the method may include submerging at least a portion of the substrate into the electrolytic substance. The coating may include the cadmium. At least a portion of the surface may include tin. The coating may include the cadmium and the tin. At least a portion of the surface may include a cadmium stannate. The coating may include the cadmium stannate. The substrate may include a glass. The glass may include a soda-lime glass. The power source may include a DC source. The electrolytic substance may include sodium hydroxide, potassium hydroxide, sulfuric acid, or hydrochloric acid solution. The current may be in the range of about 0.2 to about 0.6 A or about 0.3 to about 0.5 A. The voltage may be in the range of about 4 to about 12 V or about 10 to about 11 V. The electrolytic substance may include an acid, a base, or a salt. The electrolytic substance may include a chloride. The electrolytic substance may include a hydrochloric acid. The electrolytic substance may include a hydrochloric acid concentration in the range of about 0.1 to about 1.0%. The hydrochloric acid concentration may be about 0.2%. The hydrochloric acid concentration may be about 0.9%. The anode material may include a stainless steel, a titanium alloy, or a graphite. The method may include fixing the substrate in a holder, where the holder is proximate to the anode material, and where at least a portion of the holder contacts the electrolytic substance. The holder may include a conductive material. The holder may include a steel-mesh basket. The method may include rotating the holder or the steel-mesh basket.

Another method of removing coating from a substrate may include contacting at least a portion of a surface of a substrate to an electrolytic substance, where at least a portion of the surface includes tin; connecting a power source to the substrate and to an anode material; applying a current and a voltage; and removing at least a portion of coating from the substrate.

The method may include various optional features. For example, the method may include submerging at least a portion of the substrate into the electrolytic substance. The coating may include the tin. At least a portion of the surface may include cadmium. The coating may include the cadmium and the tin. At least a portion of the surface may include a cadmium stannate. The coating may include the cadmium stannate. The substrate may include a glass, for example, a soda-lime glass. The electrolytic substance may include an acid, a base, or a salt. The electrolytic substance may include a hydrochloric acid. The anode material may include a stainless steel, a titanium alloy, or a graphite. The power source may include a DC power source. The method may include fixing the substrate in a holder, where the holder is proximate to the anode, and where at least a portion of the holder contacts the electrolytic substance. The holder may include a steel-mesh basket. The method may include rotating the steel-mesh basket.

An apparatus for removing coating from a substrate may include a reservoir containing an electrolytic substance, where the reservoir is configured to permit contact between the electrolytic substance and a substrate; an anode; a cathode, where the cathode is configured to receive a substrate; and a power source connecting the anode to the cathode.

The apparatus may include various optional features. For example, the cathode may include a holder. The holder may include a conductive material. The holder may include a steel-mesh basket. The apparatus may include a motor, where the motor is configured to rotate the steel-mesh basket. The anode may be positioned within the reservoir, in at least partial contact with the electrolytic substance. The anode may be positioned proximate to the cathode. The anode may include a stainless steel, a titanium alloy, or a graphite. The electrolytic substance may include an acid, a base, or a salt. The electrolytic substance may include sodium hydroxide, potassium hydroxide, sulfuric acid, or hydrochloric acid solution. The electrolytic substance may include a chloride. The electrolytic substance may include hydrochloric acid. The electrolytic substance may include a hydrochloric acid concentration in the range of about 0.1 to about 1.0%. The hydrochloric acid concentration is about 0.2%. The hydrochloric acid concentration is about 0.9%. The power source may include a DC power source.

A photovoltaic module can include a transparent conductive oxide layer adjacent to a substrate and layers of semiconductor material. The layers of semiconductor material can include a bi-layer, which may include an n-type semiconductor window layer, and a p-type semiconductor absorber layer. The n-type window layer and the p-type absorber layer may be positioned in contact with one another to create an electric field. Photons can free electron-hole pairs upon making contact with the n-type window layer, sending electrons to the n side and holes to the p side. Electrons can flow back to the p side via an external current path. The resulting electron flow provides current, which combined with the resulting voltage from the electric field, creates power. The result is the conversion of photon energy into electric power. To preserve and enhance device performance, numerous layers can be positioned above the substrate in addition to the semiconductor window and absorber layers.

Photovoltaic modules can be formed on optically transparent substrates, such as glass. Because glass is not conductive, a transparent conductive oxide (TCO) layer is typically deposited between the substrate and the semiconductor bi-layer. Cadmium stannate functions well in this capacity, as it exhibits high optical transmission and low electrical sheet resistance. Other suitable TCO materials can include tin oxide and indium tin oxide. It is sometimes necessary to remove one or more coating layers from the surface of a substrate. TCO layers are conductor materials, and as such permit electron transport when DC current and appropriate voltage are applied. Thus when a substrate with a cadmium stannate TCO, for example, is contacted to or immersed within an electrolytic substance and electrically connected to a live DC power source with appropriate DC voltage, the cadmium stannate film acts as a cathode. Hydrogen evolution occurs, leading to reactive hydrogen species on the cadmium stannate. The cadmium stannate layer disproportionates and separates from the substrate. Various substances can be used for the electrolytic substance, including any suitable acid, base, or salt. For example, the electrolytic substance may include sodium hydroxide, potassium hydroxide, sulfuric acid, or hydrochloric acid solution. The electrolytic substance can be diluted. For example, the electrolytic substance can include about 100 mL of water and about 2.5 mL of 35% hydrochloric acid. It should be noted that the methods and apparatuses discussed herein may be suitable for removing various coatings and/or chemicals from various types of surfaces or substrates. For example, the methods and apparatuses discussed herein can be used to remove unwanted coatings or chemicals from large reaction shields or flat screens.

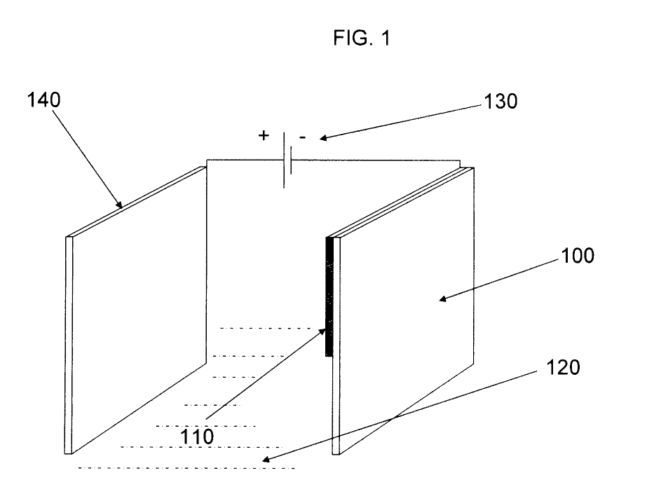

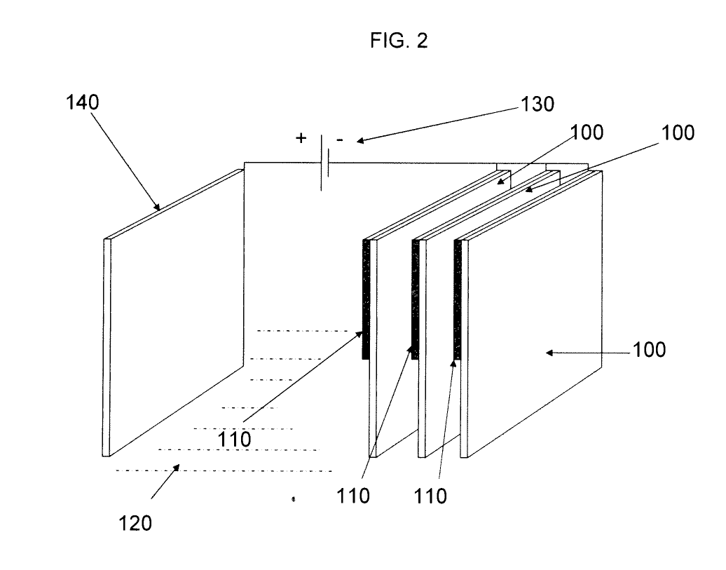

Referring to FIG. 1, substrate 100 can be immersed into electrolytic substance 120. Substrate 100 can include any suitable substrate material, including glass, for example, soda-lime glass. Substrate 100 can contain at least a portion of coating, for example, coating layer 110. Coating layer 110 can include a transparent conductive oxide layer, for example a cadmium stannate (or cadmium and tin) layer. Coating layer 110 may include any other suitable TCO material, including for example tin oxide, indium tin oxide, or cadmium tin oxide. Electrolytic substance 120 can include any suitable electrolyte, including an acid, base, or salt. For example electrolytic substance 120 may include sodium hydroxide, potassium hydroxide, sulfuric acid, or hydrochloric acid solution. Coating layer 110 can be connected to power source 130. Power source 130 can include a DC power source. An anode 140 can be connected to power source 130, permitting coating layer 110 to act as a cathode. Anode 140 can include any suitable material, including for example stainless steel, graphite, or titanium alloy. Substrate 100 with coating layer 110, and anode 140 can be placed in a steel-mesh basket and immersed in electrolytic substance 120. Referring to FIG. 2, it is possible to electrochemically leach more than one coated substrate at a time. FIG. 2 shows three substrates 100 with coating layers 110, connected to power supply 130. After contact with or submersion into electrolytic substance 120, coating layer 110 can completely delaminate and dissolve, leaving the treated substrate intact. The treated substrate may be reused, washed, or recycled.

In one embodiment, electrolytic substance 120 can include a dilute hydrochloric acid solution. For example, the hydrochloric acid concentration can be in the range of about 0.1 to about 1.0%, about 0.2 to about 0.9%, or about 0.4 to about 0.6%. Upon contacting or immersing a substrate 100 with a cadmium stannate coating layer 110 connected to a DC power source, the following reactions may take place:

(At the cathode)

2H⁺+2e=2H (1)

Cd₂SnO₄ +8H⁺+12CL⁻+2e =2CdCl₄²⁻+SnCl₄²⁻+4H₂O (2)

SnCl₆²⁻+2e=SnCl₄²⁻+2Cl⁻ (3)

SnCl₄²⁻+2e=Sn+4Cl⁻ (4)

CdCl₄²⁻+2e=Cd+4Cl⁻ (5)

SnCl₆²⁻+2H=SnCl₄²⁻+2H⁺+2Cl⁻ (6)

(At the anode)

Cl⁻+4H₂O=ClO₄⁻+8H⁺ (7)

2Cl⁻=Cl₂(aq) (8)

In another embodiment, coating layer 110 can include a tin oxide, in which case reaction (2) from above would become SnO₂+4H⁺+4Cl⁻+2e=SnCl₄²⁻+2H₂O.

Without being bound to any particular theory, at the cathode, tin(IV) is reduced to tin(II), which is soluble in hydrochloric acid solution, leading to the ultimate decomposition and dissolution of coating layer 110. Depending on the voltage of electrolytic substance 120, both tin(II) and cadmium(II) may be further reduced to metallic form. In one sample test series, both coatings of tin oxide and cadmium stannate completely dissolved when contacted with a hydrochloric acid solution. Furthermore, a relatively low hydrochloric acid concentration was used, about 0.1 to about 1.0%. Testing showed that when cell voltage was controlled at around 10 to about 11 V, the current was in the range of about 0.3 to about 0.5 A. It should be noted, however, that the range of the current is not so limited. The current can be in any suitable range, including about 0.1 to about 1.0 A, about 0.2 to about 0.8 A, or about 0.3 to about 0.5 A. For example, in one electrochemical leaching test, a current of about 0.4 A was observed, with a cell voltage of about 4.3 V. It should also be noted that the substrate can be contacted to or submerged in the electrolytic substance for any suitable duration to remove the desired amount of coating. Testing indicated that submerging or contacting a coated glass substrate with hydrochloric acid for less than about 1 hour was suitable to cause the desired dissolution and decomposition of cadmium stannate from the substrate.

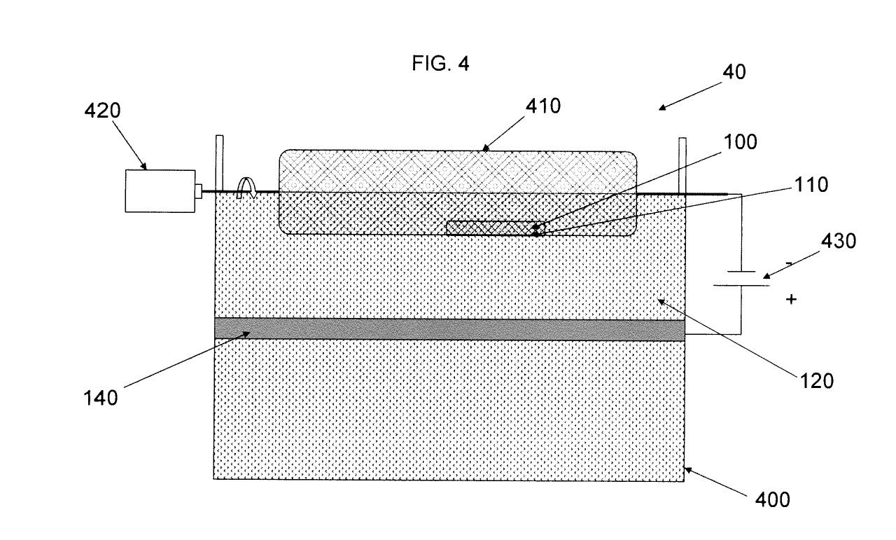

Referring to FIG. 4, an apparatus 40 for electrochemically removing coating from a substrate can include a reservoir 400 which contains electrolytic substance 120. Anode 140 can be placed in contact with electrolytic substance 120. For example, as shown in FIG. 4, anode 140 can be fully submerged within electrolytic substance 120. Substrate 100 (with coating layer 110) can then be placed into contact with electrolytic substance 120 proximate to anode 140. Referring again to FIG. 4, substrate 100 can be fixed in a holder. The holder can contain a conductive material. For example, substrate 100 can be placed into steel-mesh basket 410, which upon making electrical contact with substrate 100 can serve as a cathode. A power source 430 can connect steel-mesh basket 410 (i.e., the cathode) to anode 140, and can supply electrical current to the components.

Apparatus 40 can also include a motor 420 connected to steel-mesh basket 410. Motor 420 can rotate steel-mesh basket 410 to alter the position of coating layer 110 of substrate 100 relative to anode 140, to facilitate even dissolution and decomposition of coating layer 110. Motor 420 can be configured to rotate steel-mesh basket 410 clockwise, counter-clockwise or both, and at any suitable speed. For example, motor 420 can be configured to rotate steel-mesh basket 410 at a substantially slow rate.

Photovoltaic devices/modules fabricated using the methods and apparatuses discussed herein may be incorporated into one or more photovoltaic arrays. The arrays may be incorporated into various systems for generating electricity. For example, a photovoltaic module may be illuminated with a beam of light to generate a photocurrent. The photocurrent may be collected and converted from direct current (DC) to alternating current (AC) and distributed to a power grid. Light of any suitable wavelength may be directed at the module to produce the photocurrent, including, for example, more than 400 nm, or less than 700 nm (e.g., ultraviolet light). Photocurrent generated from one photovoltaic module may be combined with photocurrent generated from other photovoltaic modules. For example, the photovoltaic modules may be part of a photovoltaic array, from which the aggregate current may be harnessed and distributed.

The embodiments described above are offered by way of illustration and example. It should be understood that the examples provided above may be altered in certain respects and still remain within the scope of the claims. It should be appreciated that, while the invention has been described with reference to the above preferred embodiments, other embodiments are within the scope of the claims.

What is claimed is:

1. A method of removing coating from a substrate, the method comprising:
contacting at least a portion of a surface of a substrate to an electrolytic substance, at least a portion of the surface including cadmium or tin;
connecting a power source to the substrate and to an anode material;
applying a current and a voltage; and
removing at least a portion of coating from the substrate.

2. The method of claim 1, further comprising submerging at least a portion of the substrate into the electrolytic substance.

3. The method of claim 1, wherein:
the coating comprises the cadmium or tin;
the coating comprises cadmium and tin;
at least a portion of the surface comprises cadmium and tin;
at least a portion of the surface comprises a cadmium stannate; or the coating comprises a cadmium stannate.

4. The method of claim 1, wherein the substrate comprises a glass.

5. The method of claim 4, wherein the glass comprises a soda-lime glass.

6. The method of claim 1, wherein:
the power source comprises a DC source;
the current is in the range of about 0.2 to about 0.6 A; or
the voltage is in the range of about 4 to about 12 V.

7. The method of claim 1, wherein:
the electrolytic substance comprises an acid, base, or salt;
the electrolytic substance is selected from the group consisting of sodium hydroxide, potassium hydroxide, sulfuric acid, and hydrochloric acid solution;
the electrolytic substance comprises a chloride; or
the electrolytic substance comprises hydrochloric acid.

8. The method of claim 1, wherein the anode material comprises a stainless steel, graphite, or titanium alloy.

9. The method of claim 7, wherein the electrolytic substance comprises a hydrochloric acid concentration in the range of about 0.1 to about 1.0%.

10. The method of claim 1, further comprising fixing the substrate in a holder, wherein the holder is proximate to the anode material, and wherein at least a portion of the holder contacts the electrolytic substance.

11. The method of claim 10, wherein the holder comprises a conductive material.

12. The method of claim 11, wherein the holder comprises a steel-mesh basket.

13. The method of claim 12, further comprising rotating the steel-mesh basket.

14. The method of claim 1, wherein:
the substrate comprises a glass;
the power source comprises a DC power source;
at least a portion of the surface comprises a cadmium stannate;
the coating comprises the cadmium stannate; and
the electrolytic substance comprises a hydrochloric acid solution.

15. An apparatus for removing coating from a substrate, the apparatus comprising:
a reservoir containing an electrolytic substance, wherein the reservoir is configured to permit contact between the electrolytic substance and a substrate;
an anode;
a cathode, wherein the cathode is configured to receive a substrate; and
a power source connecting the anode to the cathode.

16. The apparatus of claim 15, wherein the cathode comprises a holder.

17. The apparatus of claim 16, wherein the holder comprises a conductive material.

18. The apparatus of claim 17, wherein the holder comprises a steel-mesh basket.

19. The apparatus of claim 18, further comprising a motor, wherein the motor is configured to rotate the steel-mesh basket.

20. The apparatus of claim 15, wherein:
the anode is positioned within the reservoir, in at least partial contact with the electrolytic substance; or
the anode is positioned proximate to the cathode.

21. The apparatus of claim 15, wherein:
the electrolytic substance comprises an acid, base, or salt;
the electrolytic substance is selected from the group consisting of sodium hydroxide, potassium hydroxide, sulfuric acid, and hydrochloric acid solution;
the electrolytic substance comprises a chloride; or
the electrolytic substance comprises a hydrochloric acid.

22. The apparatus of claim 21, wherein the electrolytic substance comprises a hydrochloric acid concentration in the range of about 0.1 to about 1.0%

23. The apparatus of claim 15, wherein the anode comprises a stainless steel, titanium alloy, or graphite.

24. The apparatus of claim 15, wherein the power source comprises a DC power source.
